(19) United States
(12) Patent Application Publication
(10) Pub. No.: US 2005/0009694 A1
(43) Pub. Date: Jan. 13, 2005

(54) Catalysts and methods for making same

(76) Inventors: Daniel J. Watts, Monmouth Junction, NJ (US); Dongguang Wei, Kearny, NJ (US); Shan Xiao, North Arlington, NJ (US)

Correspondence Address: FULBRIGHT & JAWORSKI, LLP, 666 FIFTH AVE, NEW YORK, NY, 10103-3198, US

(21) Appl. No.: 10/881,319

(22) Filed: Jun. 30, 2004

Related U.S. Application Data
(60) Provisional application No. 60/484,044, filed on Jun. 30, 2003.

(51) Int. Cl. B01J 23/42

(52) U.S. Cl. 502/304; 502/339

(57) ABSTRACT

Catalysts have a catalytic substrate impregnated with a catalytically active metal, and are prepared by adjusting the pH of a solution of catalytic metal ions to precipitate a layer of catalytic metal on the support.

This application claims priority from U.S. Provisional Application No. 60/484,044 filed Jun. 30, 2003, hereby incorporated by reference.

### FIELD OF THE INVENTION

The present invention relates to catalysts made of a catalyst support (substrate) having a highly dispersed catalytic metal layer containing a catalytically active metal or metal ion on the surface thereof. The catalyst can be any suitable porous material, e.g, aluminum oxide. The metal layer will generally be a salt of a catalytically active metal, e.g., a hydroxide salt, but, other forms of the catalytically active metal, e.g., oxides, or even zero valence metal may be present. The catalytically active metal is preferably palladium. The catalysts are prepared by contacting a catalyst support with a suitable amount of a solution containing an ion of the catalytically active metal so that a highly dispersed metal layer is formed thereon. The catalyst may then optionally be calcined.

Importantly, the pH is adjusted during the process to 7 or above instantaneously, that is, for purposes of the present invention, a rapid change in pH that can be defined as all at once or as close to all at once as possible, to minimize crystal size of the catalytic metal species on the surface of the support, which maximizes the catalytic sites available for reaction. This can be accomplished, e.g., by rapidly adding in one portion the pH adjusting solution containing the necessary amount of base to the catalytic metal solution to adjust the pH to 7 or higher, e.g., up to 14.

### BACKGROUND AND SUMMARY OF THE INVENTION

The most common commercial procedure for dispersing a catalytically active species, e.g., palladium, within the interstices of a carrier (support), e.g., Al₂O₃, is by impregnating with an aqueous solution containing a salt (precursor) of the catalytic element or elements (M. Komiyama, Catalysis Reviews: Sci. Eng. 27(2): 342-372, 1985; A. H. Thomas, Brundrett, C. P., Chemical Engineering Progress 76(6): 41-45, 1980; J. H. Worsell, Chemical Engineering Progress 88(6): 33-39, 1992; A. Stiles, Catalyst Manufacture: Laboratory and Commercial Preparations. New York: Marcel Dekker, 1983 and D. Trimm, Design of Industrial Catalysts. Amsterdam: Elsevier Scientific, 1980). Most preparations simply involve soaking the carrier in the solution and allowing capillary and electrostatic forces to distribute the salt over the internal surfaces of the porous network. The salt generating the cations or anions containing the catalytic element is chosen to be compatible with the surface charge of the carrier to obtain efficient adsorption or, in some cases, ion exchange. For example, Pt(NH3)₂⁺¹ salts can ion exchange with H⁺ present on the hydroxy containing surface of Al₂O₃. Anions such as PtCl₄⁻² are electrostatically attracted to the H⁺ sites. The isoelectric point of the carrier (the charge assumed by the carrier surface), which is dependent on pH, is useful in making decisions regarding salts and pH conditions for the preparation.

There are at least three methods of preparing catalysts: capillary impregnation, electrostatic adsorption, and ion exchange. Capillary impregnation, or the incipient wetness approach, is the most commonly used and easiest to control. Most laboratories and manufacturers are capable of implementing it. In this method, the maximum water uptake by the carrier is referred to as the water pore volume. This is determined by slowly adding water to a carrier until it is saturated, as evident by the beading of the excess H₂O (R. M. Heck, R. J. Farrauto, Catalytic Air Pollution Control, New York: Van Nostrand Reinhold, 1995). The precursor salt is then dissolved in an amount of water equal to the carrier pore volume. Once dried, the carrier pore structure is certain to contain the precise amount of catalytic species that was desired for the particular preparation.

Catalytic performance of catalysts is strongly influenced by the preparation variables. The dispersion and distribution, and accordingly the chemical states of surface species depend on various preparation parameters, such as metal content, pH, calcination temperature, carrier properties, but to different extents (R. W. Maatman, C. D. Prater, Ind. Eng. Chem., 49: 253, 1957; R. W. Maatman, Ind. Eng. Chem., 51:913, 1959; J. C. Summers, L. L Hegedus, J. Catal., 51:158, 1978; E. R. Becker, T. A. Nuttall, in: B, Delmon, P. Grange, P. A. Jacobs, G. Poncelet (Eds.), Preparation of Catalysts II, Amsterdam: Elsevier Scientific, 1978, p.159; M. Komiyama, R. P. Merrill, H. F. Harnsberger, J. Catal., 63: 35, 1980; K. Kottor, L. Riekent, in: B, Delmon, P. Grange, P. A. Jacobs, G. poncelet (Eds.), Preparation of Catalysts II, Amsterdam: Elsevier Scientific, 1978, p. 51; G. H. van den Berg, H. Th. Rijnten, in: B, Delmon, P. Grange, P. A. Jacobs, G. Poncelet (Eds.), Preparation of Catalysts II, Amsterdam: Elsevier Scientific, 1978, p. 256; L. L. Hegedus, T. S. Chou, J. C. Summers, N. M. Potler, in: B, Delmon, P. Grange, P. A. Jacobs, G. Poncelet (Eds.), Preparation of Catalysts II, Amsterdam: Elsevier Scientific, 1978, p. 171; H. C. Chen, R. B. Anderson, Ind. Eng. Chem. Prod. Res. Dev., 12: 122, 1973; R. Srinivansan, H. C. Liu, S. W. Weller, J. Catal., 57: 87, 1979; J. L. G. Fierro, P. Grange, B. Delmon, in: B, Delmon, P. Grange, P. A. Jacobs, G. poncelet (Eds.), Preparation of Catalysts IV, Amsterdam: Elsevier Scientific, 1987, p. 591 and M. A. Goula, Ch. Kordulis, A. Lycourghiotis, J. Catal., 133: 486, 1992).

There is a need in the art for catalysts with improved catalytic performance, and for new methods of preparing these. The present invention is directed to improved catalysts comprising highly dispersed catalytically active metal, e.g., palladium dispersed over a suitable catalyst substrate, e.g., aluminum oxide. In general, the present invention provides improvement by allowing the preparation of a catalyst-support system with a high degree of distribution of catalytic sites over the surface of the support. This provides more efficient use of the catalytic metals that are used and provides more sites per unit weight of the catalyst-support system to initiate or facilitate the expected chemical reactions.

The catalysts of the invention are suitable for many uses, for example, palladium catalysts in accordance with the invention, wherein the palladium in a finely divided state and properly supported (and frequently in the form of palladium oxide) serves as a suitable catalyst and is used to decrease the reaction time of hydrogenation and dehydrogenation reactions-transforming alkenes to alkanes (or vice versa), as well as hydrogenating aromatic rings. Some of the metals on these types of supports have been shown to catalyze the formation of carbon nanotubes and related polycarbon structures. Many of the metals, on appropriate supports, are useful in catalytic converters in motor vehicles to reduce the level of contaminants in the emission streams.

The catalysts, which include a metal layer containing a catalytically active metal or metal ion on a catalytic support such as aluminum oxide are prepared by contacting the catalyst substrate with an aqueous solution containing a catalyst metal under conditions, e.g., concentration of catalyst metal, or pH, to form a highly dispersed metal layer and optionally calcining, preferably at a temperature of from 300 to 700° K., to form the catalyst. The resultant catalyst has a highly dispersed metal layer thereon. Preferred conditions will vary depending on several factors including the species of catalytic metal used, but must form a highly dispersed metal layer on the substrate. It is recognized that for some catalytic operations, calcination may not be desired or necessary. In such situations, the highly dispersed catalytic bodies on the surface of the support can be used directly. These bodies also are relatively small compared to standard methods of catalyst preparation and promote efficiency in use of materials. It is further recognized that calcinations can take place in oxidizing, reducing, or inert atmospheres and under such conditions the metal form may be oxidized or reduced, depending on the needs of the ultimate use.

The catalytically active metal will be present in the metal layer in any form, e.g., ionic, zero valence, coordination compound, oxide, etc., although the desired form may vary according to the metal, the expected catalytic use, the reaction environment and other factors known to those skilled in the art.

In a preferred embodiment, a solution of catalytic metal (measured by weight of the catalytic metal) is prepared by mixing an appropriate amount of a salt of the metal in a suitable aqueous solvent to form a mixture or dispersion, adding the catalyst support oxide and allowing contact for a sufficient time so that the catalytic metal coats the surface of the catalyst support.

In particularly preferred embodiments, the pH of the substrate/catalyst slurry, which is acidic, is adjusted to a pH of from at least 7 to 14 by addition of a base, e.g., ammonium hydroxide. The base is preferably added all at once to effect a rapid change of the pH of the solution. This rapid addition and resulting rapid pH change minimizes the crystal size of the catalytic metal species on the substrate, which maximizes the available catalytic sites, thereby increasing the effectiveness of the catalyst.

### BRIEF DESCRIPTION OF THE DRAWINGS

In these drawing descriptions and elsewhere, the term X % of palladium on aluminum oxide refers to a combination where a ratio of 100 of substrate and X of palladium oxide (both by dry weight) exists.

FIG. 1 is a graph of Ultra-High purity 5% H2 pulse chemisorption on a 0.1392 g 3% PdO/Al₂O₃ substrate.

FIG. 2 is a graph showing the effect of palladium loading based on the metal dispersion.

FIG. 3 is a graph showing the effect of palladium loading on metal crystallite size.

FIG. 4 is a graph showing the effect of palladium on the number of moles of active site.

FIG. 5 shows XRD patterns of 1-4% palladium on aluminum oxide catalysts.

FIG. 6 is a graph showing the effect of calcination temperature on palladium dispersion.

FIG. 7 is a graph showing the effect of calcination temperature on palladium crystallite size.

FIG. 8 is a graph showing the effect of calcination temperature on the number of active sites.

FIG. 9 shows XRD patterns of 4% Pd/Al₂O₃ catalysts calcined at different temperatures.

FIG. 10 is a graph showing the pH on 3% palladium dispersion and moles of active sites on 150 m²/g gamma aluminum oxide.

FIG. 11 is a graph showing the effect of pH on 3% palladium crystallite size on 150 m²/g gamma aluminum oxide.

FIG. 12 shows XRD patterns of 3% Pd/Al₂O₃ catalysts prepared under different pH values.

FIGS. 13 is an electron micrograph comparing palladium particles (dark portions) on an Al₂O₃ substrate pH unadjusted prepared as set forth in Example 3.

FIG. 14 is an electron micrograph of palladium particles (dark portions) on an Al₂O₃ substrate with the pH adjusted in accordance with the invention. Compared to FIG. 13, the palladium particles are smaller.

### DETAILED DESCRIPTION

The present invention provides a catalyst having a coating of a catalytic crystalline layer of a catalytic metal on a suitable catalyst substrate. It is well known that catalyst substrates such as Al₂O₃ do not have smooth surfaces; rather they are porous and irregular, having in essence many hills, valleys, etc., which increase the surface area compared to a flat, smooth surface. This is desirable because the catalytical metal applied thereto will be spread over a larger surface area and, therefore, will have more catalytic sites exposed. For purposes of the present invention, the term “impregnate” will be used to refer to the application of catalytic metal to the substrate to form a well-distributed surface of the catalytic metal on the catalytic substrate. The goal is to provide a layer of catalytic material on all of the exposed rough surface of the catalyst substrate, or, at least as much of the surface as possible to provide maximum catalytic sites on the catalyst. Thus, so long as the metal is in some form affixed, adhered or otherwise associated (e.g., adsorbed) to the support surface so that it can perform its intended function, it will be sufficient for the present invention.

Suitable catalyst supports include porous, metal oxides such as oxide of aluminum, silicon, titanium, lanthanide series metals, or mixtures thereof are preferred. Cobalt, copper and iron may also be used. Titanium dioxide and dialuminum trioxide are only two of many oxides that are suitable for use with the present invention. These can be prepared as known in the art or as may hereafter be discovered. The support will preferably be in a particulate form, e.g., granules.

The catalytically active metal may be palladium, cobalt, rhodium, ruthenium, gold, platinum, iron, molybdenum, nickel, or other catalytically active metal or combination of metals. It may be present in metallic, ionic or any suitable form that will provide the intended catalytic properties.

Solutions containing ions of the catalytic metal may be formed by adding a water-soluble salt of the catalytic metal to water. Preferably, the solution contains 0.1-20 wt. % of the catalytic metal, more preferably from 1 to 4 wt. %, and most preferably from 2-4 wt. %. Preferably, the amount of water used will be an amount that can be totally absorbed by the catalyst so that no or only moderate drying is necessary. In a typical application, the concentration of the soluble metal salt in water will be adjusted to assure that the desired loading of the active form of the catalytic metal will be adsorbed on the substrate. The desired loading will vary but typically will be in the range of from 1 to 4% of the active metal or metal salt.

The catalysts are prepared by contacting a catalyst support with a suitable amount of a solution comprising an ion of at least one catalytically active metal to form a layer containing the catalytic metal on the catalyst support. This is accomplished by adjusting the pH of the acidic catalytic metal solution instantaneously, or nearly all at once, to 7 to precipitate an insoluble layer of the catalytically active metal onto the support. The pH change will cause the metal layer that contains the catalytically active metal, in any form, to precipitate onto the catalyst support and impregnate the support.

In preferred embodiments a slurry of the ionic solution of the catalytic metal and powdered catalyst support can be made by adding the powdered catalyst support to the solution, usually with mixing. The volume of the solution has been calculated based on an earlier determination of the pore volume of the support to insure that all of the solution is taken up by the support.

The pH is adjusted by adding a solution of base to the mixture of the catalyst support and the catalytic metal. Strong bases such as KOH, NaOH, and other hydroxides, e.g., NH₄OH are preferred, but any suitable base may be used. Preferably, these bases have to possess relatively higher pH value (e.g., higher than 10) for achieving quick precipitation of metal ions (hence higher dispersion). In addition, these bases preferably have to be nonmetallic containing solutions, meaning that no contamination is left on the catalysts after calcination. Many organic bases are suitable for this application. For some applications such as preparation of catalysts for carbon nanotube formation, other bases such as LiOH have been shown to be useful (Y- I. Jung, H. Wang and Y -M. Chiang, J. of Materials Chemistry, 1998, 8, 2761-4). Where the use of such bases does not leave cations that interfere with the desired catalytic process, such alternate bases are acceptable.

A sufficient amount of base is added rapidly so that the pH changes to 7 or above in rapid fashion, as discussed above.

The rapid change in pH causes the catalytic metal to precipitate as a salt onto the catalyst support material. Smaller crystals or agglomerates with a greater number of catalytic sites result compared to a method which does not provide for such a rapid change in pH.

The catalyst may optionally be dried by heating at temperatures less than calcining temperatures, e.g., less than 50° C.

The resultant catalyst impregnated with the catalytically active metal may then optionally be calcined at temperatures of from 300 to 800° K. for periods ranging from one minute to several days, e.g., 3 to 12 hours. Calcining may be conducted in an inert atmosphere, e.g., with Argon or Helium gas or where desirable to produce the desired form of the catalyst can be conducted in a hydrogen or in an oxygen-containing atmosphere.

The catalyst may contain many forms of the metal, e.g., the salt, ionic form, metallic form, oxides, etc.

### DETAILED DESCRIPTION OF PREFERRED EMBODIMENTS

Many different catalyst supports may be used with the invention as noted supra. The γ-Al₂O₃ used as the catalyst substrate in the Examples provided below was supplied by Mobil Corporation. It has 120 m²/g surface area, and is 20 microns in size (referred to herein as granules). All γ-Al₂O₃ samples were aged at 873° K. for 6 hr before impregnation. The palladium nitrate and ammonia used were of analytical grade.

The dispersion of palladium on γ-Al₂O₃ for all of the catalyst preparations was measured by using the pulse chemsorption method in an Altmira instrument (Altmira-I). Weighed powder catalyst samples (0.1˜0.15 g) were first reduced at 673° K. for 3 h with 30 ml/min ultra high purity 5% H₂ in Argon, followed by flushing for 2 h at the same temperature with 30 ml/min ultra high purity Argon. Then pulse chemsorption was carried out with 30 ml/min ultra high purity 5% H₂ in Argon at 353° K., with 30 ml/min ultra high purity Argon as carrier gas. The number of catalytically active sites was calculated using the method provided in the Altmira instrument manual.

X-ray powder diffraction patterns of the samples were measured on a Philips X'pert PW3040-MPD XRD.

### EXAMPLE 1

Effect of Palladium Loading on the Dispersion of Palladium on Al₂O₃ Substrate

This catalyst series consists of 4 catalysts with 1 wt. %, 2 wt. %, 3 wt. %, 4 wt. % palladium loaded on aged γ-Al₂O₃. (The term X wt. % of palladium on aluminum oxide refers to a combination where a ratio of 100 of substrate and X of palladium oxide, both by dry weight, exists. Palladium nitrate corresponding to the aforementioned different percent metal loadings was dissolved in distilled water with a volume corresponding to the water pore volume of 1 g γ-Al₂O₃. A one gram (1 g) portion of γ-Al₂O₃ granules was then added into this solution followed by soaking over night in a sealed container so that the palladium was absorbed on the γ-Al₂O₃ surface. The sample was further dried at 373° K. for 3 h in a quartz reactor with helium flow though the reactor. Finally, the sample was calcined in a furnace.

The temperature was raised stepwise to 523° K., 623° K., 723° K. for 1 h at each temperature and finally kept at 723° K. for 4 h. The helium flowed through the reactor during the whole calcination process. The palladium dispersion and metal crystal size were measured by the pulse chemsorption method in the Altamira instrument. The dynamic pulse flow technique [See, e.g., J. Prasad, P. G. Menon, J. Catal. 44:314, 1976; C. Serrano, J. J. Carberry, Appl. Catal. 19:119, 1985; J. Prasad, K. R. Murthy, P. G. Menon, J. Catal. 52:515, 1978; and Z. Schay, K. Matusek, L. Guczi, Appl. Catal. 10:173, 1984 for adsorption measurement and the modified stoichiometry proposed by O'Rear et al. in J. Catal. 121:131 (1990)] was used to calculate the accessible metal fraction.

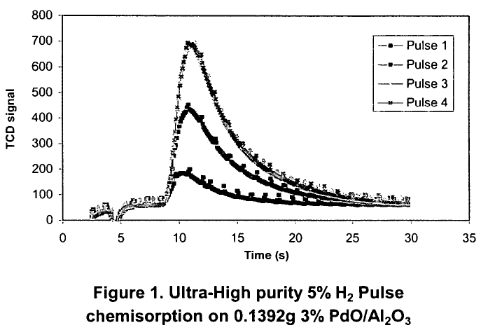

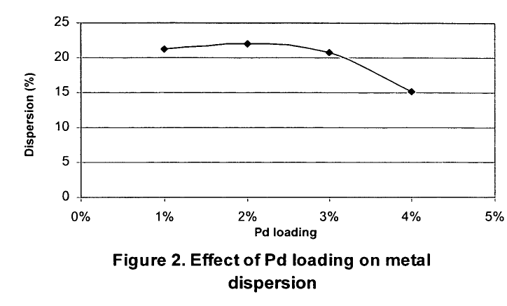

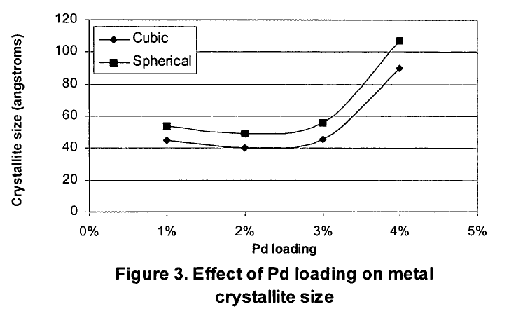

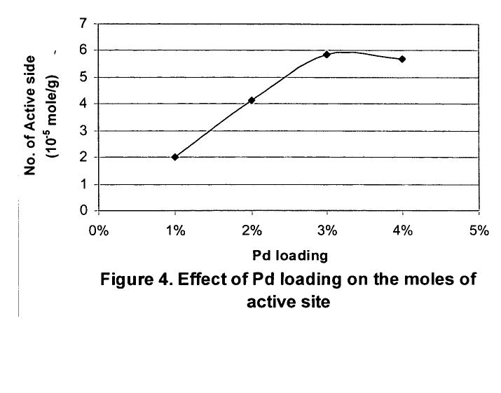

FIG. 1 depicts one of the chemsorption experimental results, and FIG. 2 shows the calculated result for the Pd dispersion on Al₂O₃ of the 4 catalysts in Example 1. FIG. 2 shows that the Pd dispersion decreases as the metal loading increases from 1% to 4 wt. %. Pd crystal size grows as the metal loading increases, as shown in FIG. 3. The calculated results of number of moles of active (catalytic) sites per gram of sample are shown in FIG. 4 and it can be seen that the active sites increase as the metal loading increases, reaching maximum value at approximately 3 wt % Pd loading. Further increase of Pd loading to 4 wt. % results in a decrease of Pd dispersion. It seems that until the Pd loading reaches 3 wt. %, the Pd dispersion on the Al₂O₃ is very high. This is indicated by the fact that the Pd dispersion eventually stays near constant in this metal concentration range and the number of active sites increases due to the metal concentration increasing. When the Pd load reaches approximately 3 wt.%, the metal reaches its dispersion capacity on the Al₂O₃, as indicated by the observation that the dispersion and the number of active sites decrease as the Pd loading increases from 3 wt. % to 4 wt. %.

One additional catalyst, an 8% Pd supported on Al₂O₃ was made for this example. The chemsorption results show that the dispersion of this catalyst decreases to 6.3% from around 20% for the 1-3% Pd loading samples. The active sites for this catalyst decrease to 4.735 E-5 moles/g, which is lower than both the 3% and the 4% Pd loading catalysts.

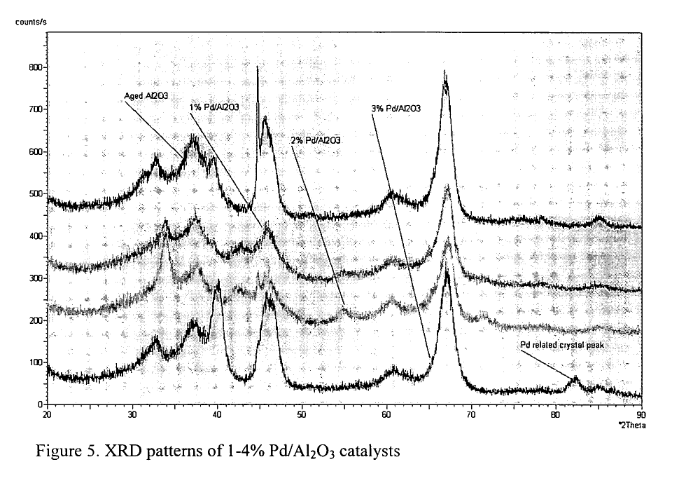

The results show that 3 wt. % Pd loading seems to have reached the capacity of the Al₂O₃ support (in this example) for accommodating Pd species at its highest dispersion. When Pd loading exceeds 3%, it is believed, that Pd crystals will further grow on the surface of the Al₂O₃, and that the Pd crystal size will increase with increasing Pd load. The XRD results shown in FIG. 5 show consistent information about the Pd crystal phase. Further increases in Pd loading do not compensate for the decreases resulting from crystal growth, and the active sites on the catalysts decrease.

### EXAMPLE 2

Effect of Calcination Temperature on a Palladium Dispersion with an Al₂O₃ Substrate

This catalyst series consists of 3 catalysts with 3 wt. % palladium, and 3 catalysts with 4% palladium loaded on aged γ-Al₂O₃. Palladium nitrate corresponding to 3%, and 4% palladium loading was dissolved in distilled water at a volume corresponding to the water pore volume of 1 g γ-Al₂O₃ . One gram of γ-Al₂O₃ was then dropped into each of these solutions, and it was allowed to soak over night in a sealed container so that the palladium adsorded onto the γ-Al₂O₃ surface. The sample was further dried at 373° K. for 3 h in a vertical quartz reactor with helium downflow through the reactor. Finally, the sample was calcined in a furnace. The 3 samples of each Pd loading percentage were calcined at 473° K., 623° K., 773° K. for 4 hours respectively. The helium flowed through the reactor during the whole calcination process.

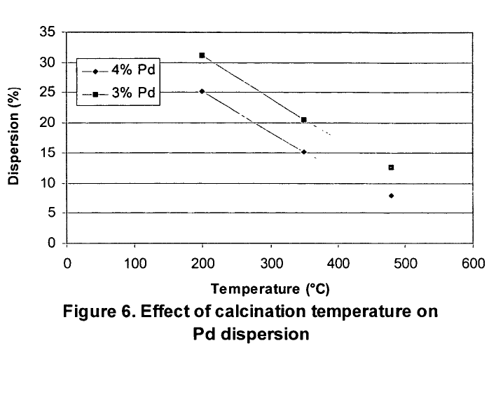

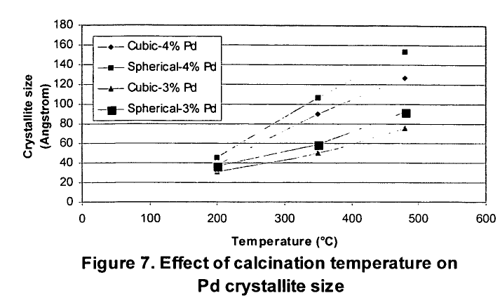

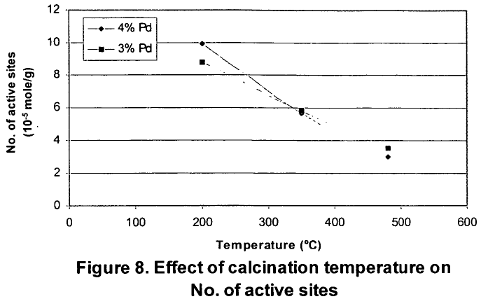

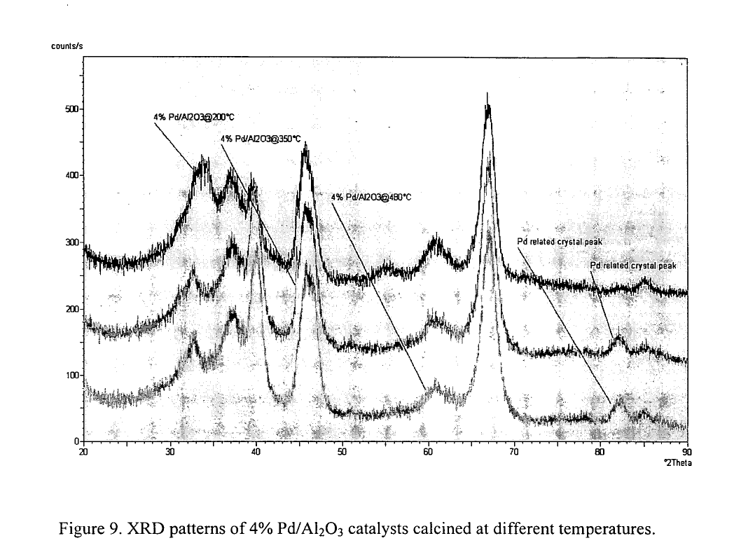

FIG. 6 shows that Pd dispersion decreases from 31 wt. % to 12.6 wt. % for 3 wt. % Pd/Al₂O₃ and from 25 wt. % to 7.9 wt. % for 4% Pd/Al₂O₃ as the calcination temperatures increased. Palladium oxide crystallites increased in size 3.3 times for 4% Pd/Al₂O₃ and 2.5 times for 3 wt. % Pd/Al₂O₃, and the calculated active sites decreased the same magnitude when calcination temperature increased from 473° K. to 723° K., as shown in FIGS. 7 and 8. This phenomenon suggests that the catalysts underwent the sintering process that is induced by thermal effects. Because the carrier Al₂O₃ was aged at 873° K. for 6 h before preparation of catalysts, it is believed that initially the Pd was well dispersed on the surface but sintering continued as the calcination temperature increased. The XRD pattern in FIG. 9 also shows the growth in crystal structures. It is common for a highly dispersed catalytic species to undergo growth to better-defined crystals. As the temperature increases, the active species on the surface tend to migrate together and grow. As this process proceeds, the crystals grow larger and the surface to volume ratio decreases, leaving fewer metal atoms on the surface of the crystal available to the reactant. In other words, fewer active sites are available for reactions to take place.

There are two models that have been proposed for the mechanism of the sintering process. The first mechanism was developed by Ruckenstein and Pulvermacher (E. Ruckenstein, J. Catal. 26:70, 1972; E. Ruckenstein, B. Pulvermacher, J. Catal. 29:224, 1973; E. Ruckenstein, B. Pulvermacher, J. Catal. 35:115, 1974; E. Ruckenstein, B. Pulvermacher, J. Catal. 37:416, 1975; E. Ruckenstein, D. R. Dadyburjor, J. Catal. 48:73,1977) who described a migration of metallic particles. The crystallites move on the surface of the carrier until they can meet a second particle leading to a fusion of both particles into a bigger crystallite. But this mechanism cannot explain the redispersion effect observed on some given metals.

A second model published by Wanke and Flynn (P. C. Flynn, S. E. Wanke, J. Catal. 34:390, 1974; P. C. Flynn, S. E. Wanke, J. Catal. 34:400, 1974; S. E. Wanke, J. Catal. 44:234, 1977 ; A. G. Grahams, S. E. Wanke, J. Catal. 68:1, 1981) is based on the migration of molecular species. Atomic and molecular species can be formed from the smallest crystallite; they are then able to diffuse on the surface of the support until they are trapped by bigger crystallites; thus the bigger crystallites will grow at the expense of the smaller particles.

For big crystallites, the rate of the loss of metal atoms to form molecular species will be lower than the rate of species binding, the reverse being true for small crystallites. When the rate is the same, the sintering process is completed. Therefore, in the case of the Wanke mechanism, the sintering process will facilitate the movement of atomic material away from the smallest particles. In this case a bimodal size distribution can be expected after sintering as the small particles become smaller and larger particles become even larger. According to Ruckenstein, smaller particles will congregate, leading to the formation of larger crystallites with monomodal size distribution and the smallest crystallites will form only at the beginning of the process before moving on the carrier surface. Thus, the distribution will contain a large size range including the remainder of the smallest crystallites. Based on the published studies, the sintering process of the present invention corresponds particularly well to the mechanism of Wanke.

The above theories of how the crystals may be forming, or any other theories offered elsewhere herein, offer the reader a possible explanation to better understand the invention. These theories are not meant to have a limiting effect on any claims directed to the invention.

### EXAMPLE 3

Effect of pH on the palladium dispersion on Al₂O₃ Five (5) catalysts were prepared to yield 3 wt % palladium loaded on aged γ-Al₂O₃ but were impregnated at different pH conditions. Palladium nitrate corresponding to 3 wt % palladium loading was dissolved in distilled water with a volume corresponding to the water pore volume of 1 g γ-Al₂O₃, the solution had pH of around 1. One gram (1 g) of γ-Al₂O₃ was then dropped into this solution, the resulting mixture had a pH of slightly below 3. Next, 7.2 N NH₄OH solution was used to adjust four of the five individual preparations to a pH of 5, 6, 8, or 10, respectively, immediately after completion of the alumina addition and drying of the samples as discussed in Example 1 (in other words, the ammonium hydroxide solution was added all at once to the mixture to effect a rapid pH change). This was followed by soaking over night in a sealed container so that the palladium adsorbed on the γ-Al₂O₃ surface. The sample was further dried at 373° K. for 3 h in a vertical quartz reactor with helium downflow through the reactor. Finally, the sample was calcined in a furnace. The five samples were calcined at 623° K. for 4 h, respectively. The helium flowed through the reactor during the whole calcination process.

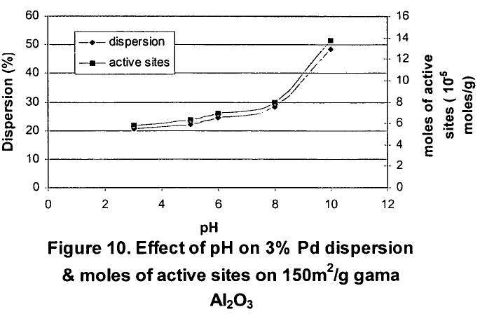

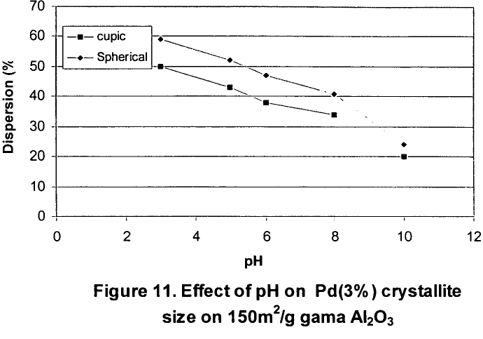

FIG. 10 shows the effect of pH on palladium dispersion and the number of active sites. In acidic condition (pH<7), the dispersion of palladium gently increases with pH increases. As the pH exceeds 7, the resultant impregnation slurry is under basic conditions, and further increasing of the pH results in a tremendous increase in the palladium dispersion. The dispersion reached a maximum of 48% as the slurry pH reaches about 10 to 11 as indicated by the presence of excess NH₄OH, indicating that all of the base-mediated reactions have been completed. This dispersion is much higher than that demonstrated by an Engelhard commercial catalyst, 4 wt. % Pd/Basios, and slightly lower than its 1.5% Pt/Al₂O₃ catalysts, which have 42.6% and 51% dispersion respectively. The number of active sites on the surface exhibits a similar change as the pH increases, also shown in FIG. 10. FIG. 11 shows a corresponding decrease in palladium crystallite size as pH increases from 3 to 10.

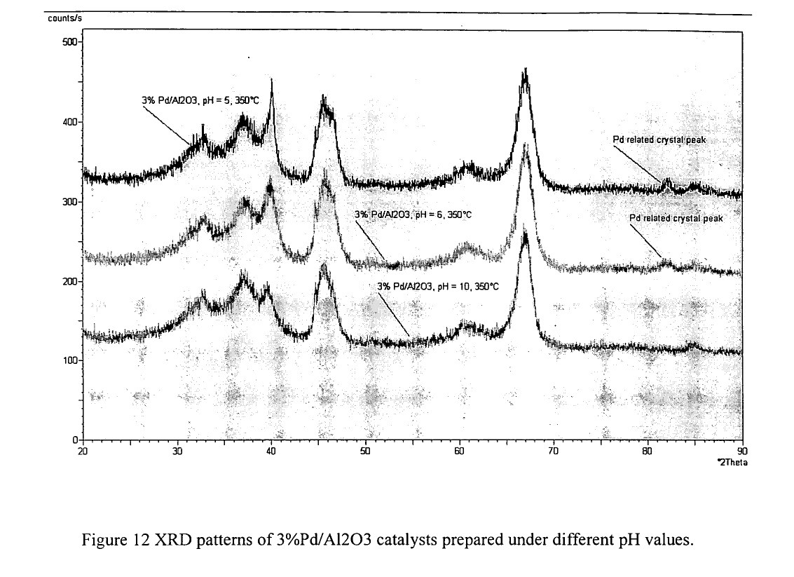

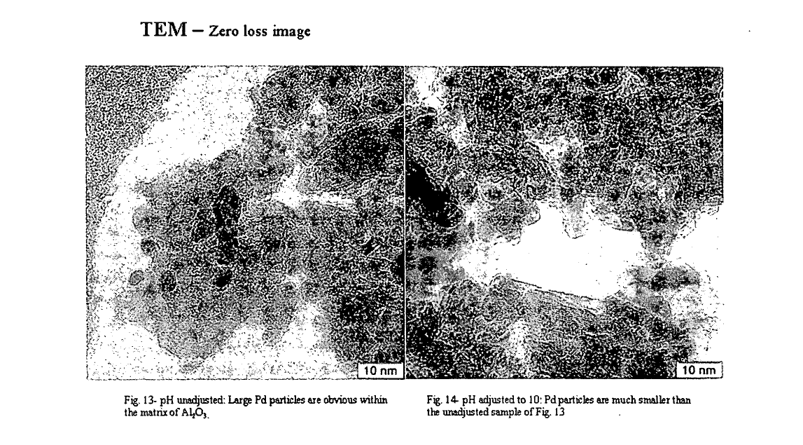

Initially, it appears that well dispersed Pd can migrate and agglomerate to form bigger crystallites during drying, and high temperature calcination. It is preferable to fix the catalytic species so that subsequent processing steps will not cause significant movement or agglomeration of well-dispersed catalytic species. When the pH of the impregnation slurry is adjusted, the catalytic species is precipitated onto the surfaces outside and inside the Al₂O₃ of the carrier substrate. When pH<7, there are insufficient hydroxide ions to precipitate all of the catalytic species, e.g. Pd. Most of those species are mobile; therefore the dispersion only increases slightly with an increase in pH. When there is excess hydroxide ion present as indicated by pH values in the range of 10-11, the Pd precipitates quickly on all of the surfaces, including those inside the pores of the Al₂O₃ as the hydroxide ions reach the surfaces where the Pd⁺⁺ ions are located and then are anchored locally to the surface within the pore structure. The faster the pH is adjusted, the faster the rate of precipitation, and the smaller the crystal size. This disables the mobility of the catalytic species, resulting in a high Pd dispersion. In other words, lower pH leads to more aggregation of Pd and a more prominent steric hindering effect than does a higher pH. The change in the XRD pattern that supports this interpretation is shown in FIG. 12.

In some commercial practices, precipitation of catalytic species is done by presoaking carriers with NH₄OH, followed by the addition of an acidic Pd salt, such as Pd(NO₃)₂, which causes precipitation of hydrated PdO on the surface of the pores within the carrier. However, the pores within the carrier may fill with NH₄OH solution, and Pd(OH)₂ may form and crystallize before it reach the surface of those pores, thus those small crystallites may aggregate to bigger crystallites, or block the entry of the pores. In contrast, by impregnating Al₂O₃ with Pd(NO₃)₂ solution first, Pd has the opportunity to preferably distribute on the surface of the Al₂O₃ pores, and the addition of NH₄OH will precipitate the Pd on the site where it was dispersed.

Higher calcination temperatures result in lower Pd dispersion and larger Pd crystal size due to the sintering process, which results from heating at temperatures below about 800° K., e.g., from 300-750° K., most preferably between 350-600° K.

Lower pH leads to more aggregation of palladium and more prominent steric hindering effects than does higher pH, therefore a pH of greater than 7, preferably between 9-12, most preferably 10-11, should be used in preparing catalysts of the present invention. Other catalytic metals besides palladium may be used in this procedure to achieve higher dispersion of the selected active metal than by other common procedures, including cobalt, rhodium, ruthenium, gold, platinum and other species. The pH calcination temperatures and loading percentages may vary for these species, but these can be readily determined and used to achieve a high number of active sites, as with palladium. This catalyst preparation technique can also be widely used for most of metal oxide catalyst supports, such as, silica, titania, lanthena, and their mixtures, as well as other similar materials.

It is also contemplated that catalysts of the present invention can be used to produce carbon nanotubes. Catalysts such as cobalt, copper, and iron in various forms on supports such as silica and zeolites have been shown to be useful for the preparation of carbon nanotubes (A. Fonseca, K. Hemadi, P. Piedigrosso, J. -F. Colomer, K. Mukhopadhyay, R. Doome, S. Laszrescu. L. P. Biro, Ph. Lambin, P. A. Thiry, D. Bernaerts, and J. B. Nagy, Appl. Phys A 67, 11-22 (1998). To prepare a suitable catalyst for producing nanotubes in accordance with the present invention, one will prepare a solution of a cobalt salt, such as cobalt acetate by dissolving in the quantity of water determined previously to be the pore volume of 1 gram of silica gel, dried similarly to the other examples described. The dried silica will then be mixed with the cobalt acetate solution and allowed to stand overnight in a sealed container. It may be further dried. Sufficient ammonium hydroxide solution would then be added, all at once, to raise the pH to above 7, preferably to 11. The materials will then be dried, and calcined at 450 degrees Celsius, or higher, for at least 4.5 hours. Alternatively, calcinations could be conducted in a hydrogen atmosphere to accomplish reduction of the metal.

All references cited herein are hereby incorporated by reference.

1. A catalyst prepared by contacting a catalyst substrate with a suitable amount of a solution comprising ions of at least one catalytically active metal to form a metal layer comprising the catalytically active metal on said catalyst support, wherein the pH of said solution is instantaneously adjusted all at once to 7 to precipitate the crystal layer onto said support.

2. The catalyst of claim 1, wherein said support comprises at least one support metal oxide selected from the group consisting of aluminum oxide, titanium oxide and lanthana oxides.

3. The catalyst of claim 2, wherein the catalytically active metal is selected from the group consisting of palladium, cobalt, copper, rhodium, ruthenium, gold, platinum, iron, molybdenum and nickel.

4. The catalyst of claim 1, wherein said catalytically active metal is palladium.

5. The catalyst of claim 1, wherein said catalytically active metal is cobalt.

6. A method comprising contacting a catalyst substrate with a solution comprising a catalytic metal under conditions which form a highly dispersed metal layer on said catalyst substrate to form a catalyst.

7. The method of claim 6, wherein said catalytically active metal is selected from the group consisting of palladium, cobalt, copper, rhodium, ruthenium, gold, platinum, iron, molybdenum and nickel.

8. The method of claim 6, wherein said conditions are formed by all at once addition of a solution comprising a strong base in an amount sufficient to adjust the pH to 7 or above.

9. The method of claim 8, wherein said strong base is selected from the group consisting of ammonium hydroxide, sodium hydroxide, and potassium hydroxide.

10. A method comprising contacting a catalyst substrate with a solution comprising a catalytic metal and instantaneously adjusting the pH to at least 7 or above with a base such that a highly dispersed metal layer forms on said catalyst substrate to form a catalyst.

11. The method of claim 10, wherein said strong base is selected from the group consisting of ammonium hydroxide, sodium hydroxide, and potassium hydroxide.

12. The method of claim 10, wherein said catalytically active metal is selected from the group consisting of palladium, cobalt, copper, rhodium, ruthenium, gold, platinum, iron, molybdenum and nickel.

13. The method of claim 12, wherein said catalytically active metal is palladium.

14. The method of claim 12, wherein said catalytically active metal is cobalt.

15. A method comprising contacting a catalyst substrate with a solution comprising a catalytic metal under conditions which form a highly dispersed metal layer on said catalyst substrate and calcining to form a catalyst having a highly dispersed metal layer thereon.

16. A method according to claim 15, wherein said calcining is conducted at a temperature of from 300 to 700° K.

17. The method of claim 15, wherein said strong base is selected from the group consisting of ammonium hydroxide, sodium hydroxide, and potassium hydroxide.

18. The method of claim 15, wherein said catalytically active metal is selected from the group consisting of palladium, cobalt, copper, rhodium, ruthenium, gold, platinum, iron, molybdenum and nickel.

19. The method of claim 15, wherein said catalytically active metal is palladium.

20. The method of claim 15, wherein said catalytically active metal is cobalt.
